(19) United States
(12) Patent Application Publication
(10) Pub. No.: US 2013/0291552 A1
(43) Pub. Date: Nov. 7, 2013

(54) ELECTRICAL CONTROL OF COMBUSTION

(71) Applicants: Lance L. Smith, West Hartford, CT (US); Meredith B. Colket, III, Simsbury, CT (US)

(72) Inventors: Lance L. Smith, West Hartford, CT (US); Meredith B. Colket, III, Simsbury, CT (US)

(73) Assignee: UNITED TECHNOLOGIES CORPORATION, Hartford, CT (US)

(21) Appl. No.: 13/463,425

(22) Filed: May 3, 2012

(51) Int. Cl. F02C 7/24

(52) U.S. Cl. 60/779; 60/725

(57) ABSTRACT

A system for electrically controlling combustion includes a combustion chamber, one or more sensors, an actuator, and a controller. The controller detects dynamic instabilities based upon input regarding conditions in the combustion chamber from the sensors. The actuator electrically modulates combustion, and the controller operates the actuator to counteract the dynamic instabilities.

### BACKGROUND

The present invention is related to electrical control of combustion, and in particular to electrical modulation of combustion in gas turbine engines.

Combustion systems such as a main burner or an afterburner of a jet engine can suffer from dynamic instabilities, also known as ‘screeching.’ Dynamic instabilities occur when combustion oscillations couple with acoustic oscillations to form a self-amplifying feedback loop. The acoustic oscillations, often caused by oscillations in heat release in the combustion chamber, can create oscillations in pressure at, for example, a fuel nozzle. This varying pressure can create oscillations in the amount of fuel provided for combustion, which in turn creates combustion oscillations. If these combustion oscillations are in phase with the acoustic oscillations, then energy will be provided to the acoustic oscillations causing them to amplify. The energy created by these self-amplified oscillations can cause damage to the engine components, combustor components, and in extreme cases, catastrophic failure of the engine itself.

Fuel actuation has been used to combat the effects of dynamic instability. Upon detection of acoustic oscillations, the flow of fuel to the combustor is mechanically regulated, generally at the fuel nozzle. The fuel provided to the combustion zone is oscillated out of phase with the naturally occurring acoustic oscillations in order to counteract them. There are numerous drawbacks to fuel actuation. For instance, there is time lag due to the physical separation between the location of the flame and the fuel nozzle itself. Also, due to the fuel actuation being mechanical, fuel-actuated systems have a limited frequency range or bandwidth. These factors can provide for limited attenuation of the oscillations.

### SUMMARY

A system and method of electrically controlling combustion includes a combustion chamber, one or more sensors, a controller, and an actuator. The controller uses input regarding conditions within the combustion chamber from the sensors to detect dynamic instabilities within the combustion chamber. The actuator is operated by the controller to provide electrical modulation of combustion within the combustion chamber such that the dynamic instabilities in the combustion chamber are counteracted.

### BRIEF DESCRIPTION OF THE DRAWINGS

FIGS. 1A-1C are block diagrams illustrating systems for electrically modulating combustion according to embodiments of the present invention.

FIG. 2 is a flowchart illustrating a method of electrically controlling combustion by electrically modulating heat release according to an embodiment of the present invention.

### DETAILED DESCRIPTION

The present invention describes a system for electrical control of combustion. The system includes one or more sensors coupled to a combustion chamber, an actuator for electrically modulating the combustion, and a controller that receives input from the one or more sensors, and provides output to control the actuator. The sensors are used to measure conditions within the combustion chamber. The controller monitors input from the sensors to determine if any dynamic instabilities are present. If instabilities are detected, the controller operates the actuator to electrically modulate the combustion to counteract and eliminate the dynamic instabilities.

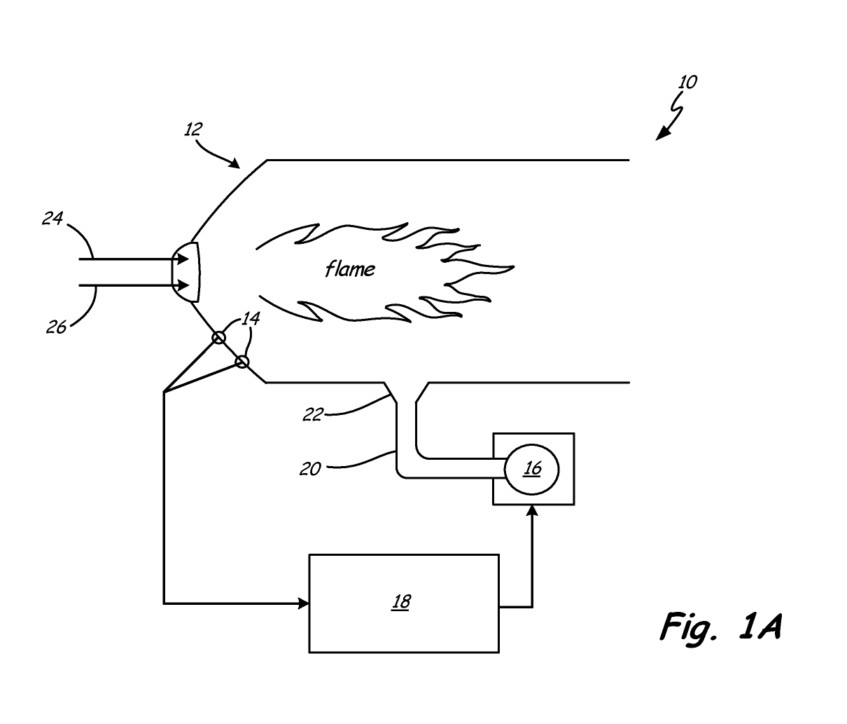

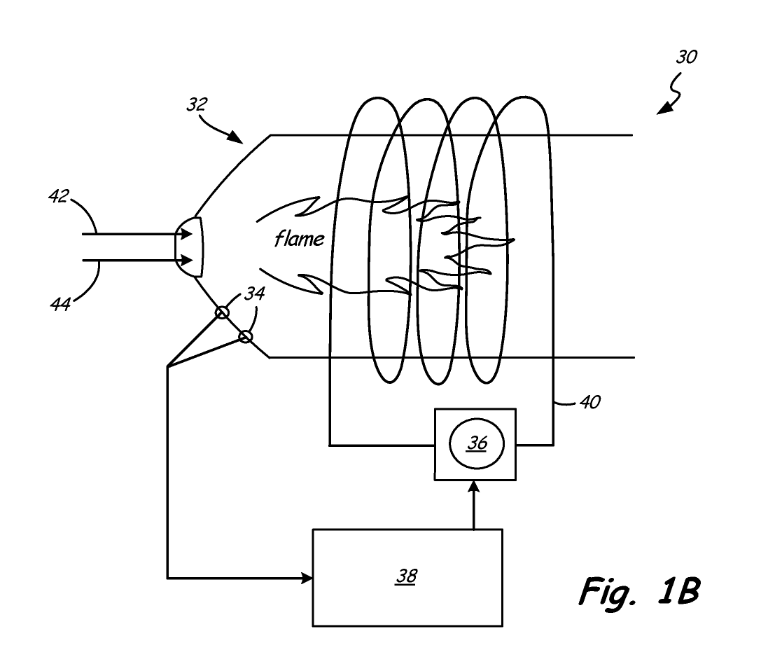

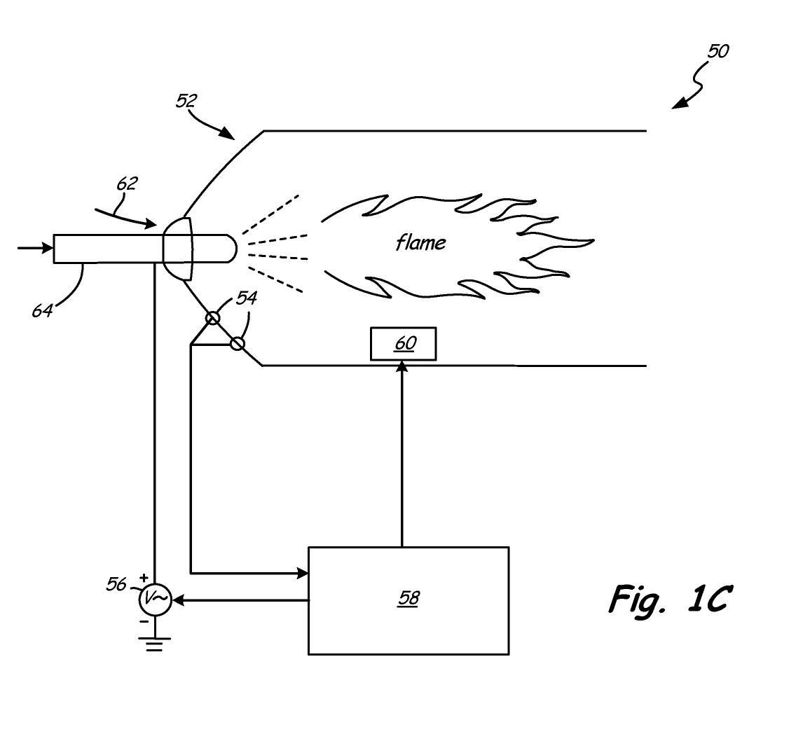

FIG. 1A is a block diagram illustrating a system 10 for electrically modulating combustion according to an embodiment of the present invention. System 10 includes combustion chamber 12, sensors 14, microwave source 16, controller 18, waveguide 20, antenna 22, air flow path 24, and fuel path 26. Combustion chamber 12 can be any chamber in which combustion takes place, such as a main burner or an afterburner of a jet engine. Controller 18 may be implemented using a microcontroller such as a field programmable gate array (FPGA). Microwave source 16 is a device that produces microwaves, such as a magnetron. Waveguide 20, and antenna 22, which may be implemented as a horn antenna, are used to guide the microwaves into combustion chamber 12.

Sensors 14 are coupled to combustion chamber 12 to measure conditions present within the chamber. In one embodiment of the invention, sensors 14 are mechanical pressure sensors. For example, a microphone can be used to measure the pressure at any given point in combustion chamber 12. Alternatively, a light detector may be used to measure the chemiluminescence of the flame. The intensity of the flame can be determined based upon the measured chemiluminescence. The measurements made by sensors 14 are provided as input to controller 18.

Sensors 14 may also be implemented using electromagnetic sensors as opposed to mechanical sensors. Combustion can be electrically monitored due to chemical ionization that occurs in the flame during combustion. For example, a pair of electrodes may be set up on each side of the flame. Using the electrodes, the capacitance can be measured to determine the intensity of the flame. Alternatively, a pair of electrodes can be placed within the flame, and the conductivity can be measured between the electrodes as the flame moves across the electrodes. This intensity is provided to controller 18.

Combustion is electrically modulated by use of an actuator. Combustion can be modulated through either flow field modulation or direct heat release modulation. For flow field modulation, an electric or magnetic field can be used to “push” any charged particles that are present to move the flame, or to move any fuel or air flows that affect the flame. Charged particles that may be “pushed” include flame ions, seed ions, ionic species, electrons, or charged liquid fuel droplets. For direct heat release modulation, electromagnetic energy can be used to locally modify the rate at which fuel is burned and heat is released. For this purpose, discharge plasmas can be generated in high-pressure flames by various means, including radio-frequency (RF) inductive or capacitive coupling, microwaves, or high-voltage electrode methods. Electromagnetic fields can also impart energy to charged particles already present in the flame, without creating a discharge, such as ionized seed particles or products of flame chemi-ionization reactions.

Methods of electrical modulation include, among other, steering the flame by convection induced by electromagnetic fields; affecting pre-flame gases by convection induced by electromagnetic fields; disrupting flow near a plasma in a high field-strength at discharge; steering electrically charged fuel droplets using an electric field; modulating rate of burning by heating a gas volume using a microwave energy input or RF inductive coupling; modulating rate of burning by local heating using arc discharges from electrodes; and modulating the rate of burning via ion participation in kinetics of fuel oxidization using a microwave source or arc discharges from electrodes.

In the present embodiment, microwave source 16, waveguide 20, and antenna 22 act as the actuator to modulate combustion by electrically affecting the flame's heat release rate. Because chemical ionization occurs in the flame during combustion, the flame can be directly influenced by electromagnetic fields. Microwaves propagate from microwave source 16 through waveguide 20 and antenna 22, and are directed into combustion chamber 12. Combustion chamber 12 may be open, such that the microwaves exit after passing through the flame, or may form a microwave resonant cavity to provide higher field strengths. Because flames contain ions, the microwaves interact with the ions, causing molecular motion which adds heat to the flame, and possibly causing further ionization that can also affect combustion. By modulating the microwave heat, input acoustic waves can be directly created, or local temperature fluctuations can be provided that, through the strong temperature-dependence of reaction rates, can modulate the local combustion heat release to counteract the effects of the dynamic instabilities. By electrically modulating combustion at the flame, the time delay introduced by mechanical actuation is eliminated.

Controller 18 is implemented with active control logic to detect and counteract dynamic instabilities. Controller 18 first determines if any acoustic or combustion oscillations are present in combustion chamber 12 based upon input from sensors 14. For example, if sensors 14 are microphones, controller 18 determines if pressure readings in the chamber are oscillating. If so, controller 18 determines the frequency and phase of the oscillations and also determines if dynamic instabilities are present based upon the amplitude of the oscillations. Once dynamic instabilities are detected, controller 18 will operate microwave source 16 to modulate the heat release of the flame out of phase with, and at the same frequency as the detected dynamic instabilities. By modulating the heat release out of phase with, and at the same frequency as the detected oscillations, the combustion oscillations are damped. This also damps the unwanted acoustic oscillations because the acoustic energy source is reduced (i.e. the amplitude of the oscillating heat release is reduced), thus reducing the gain of any naturally occurring thermoacoustic feedback loop that is present in combustion chamber 12.

FIG. 1B is a block diagram illustrating a system 30 for electrically modulating combustion according to another embodiment of the present invention. System 30 includes combustion chamber 32, sensors 34, radio-frequency (RF) transmitter 36, controller 38, coil 40, air flow path 42, and fuel path 44. Combustion chamber 32 can be any chamber in which combustion takes place, such as a main burner or an afterburner of a jet engine. Controller 38 may be implemented using a microcontroller such as a field programmable gate array (FPGA). Sensors 34, and controller 38 are implemented in a similar fashion to sensors 14 and controller 18 described above.

Radio-frequency (RF) inductive coupling is used to heat the flame. RF inductive coupling is accomplished by surrounding the flame, or a portion of the flame, with coil 40. Coil 40, along with RF transmitter 36 are used as an actuator to induce a magnetic field that oscillates at a radio frequency. Because flames contain ions and are therefore conductive, the oscillating magnetic field induces eddy currents in the flame which heat the flame due to electrical resistance, and possibly cause further ionization that can also affect combustion. RF transmitter 36 produces radio frequencies that are modulated at acoustic frequencies. The modulated RF energy input affects the undesired oscillations by providing a fluctuating heat input rate that can directly create acoustic waves of a desired phase. The modulated RF energy input also provides local temperature fluctuations that, through the strong temperature-dependence of reaction rates, can modulate the local combustion heat release rate and further counteract the unwanted oscillations.

FIG. 1C is a block diagram illustrating a system 50 for electrically modulating combustion according to another embodiment of the present invention. System 50 includes combustion chamber 52, sensors 54, voltage source 56, controller 58, electrodes and/or coils 60, air flow path 62, and fuel-injector 64. Combustion chamber 52 can be any chamber in which combustion takes place, such as a main burner or an afterburner of a jet engine. Controller 58 may be implemented using a microcontroller such as a field programmable gate array (FPGA). Sensors 54 and controller 58 are implemented in a similar fashion to sensors 14 and controller 18 described above.

A fuel spray can be electrically modulated to counteract dynamic instabilities. Here the actuation occurs near the fuel-injection site, at fuel-injector 64, as opposed to inside the flame. Because of this, a time-delay occurs between actuation and response. This time-delay corresponds to the time it takes for the fuel to be transported from fuel-injector 64 to the flame. This method is advantageous in that it does not require energy from the electrical system to heat the combustion gases, and therefore would have substantially lower power requirements than methods that rely on heating.

Fuel spray actuation is accomplished by electrically charging liquid fuel as it exits fuel-injector 64 and forms a fuel spray. In this case, voltage source 56 acts as an actuator to charge the spray. By varying the charge on the spray, the droplet breakup, transport, and evaporation physics can be varied, so that more or less fuel is delivered to the flame at any given moment. Thus, the heat release rate is varied by varying the fuel-to-air ratio at the flame. Charging of the fuel spray also enables electrodes and/or coils 60 to further affect the spray dynamics or transport by steering the charged fuel droplets in imposed electric or magnetic fields. Controller 58 can therefore vary the flame's fuel-to-air ratio at the correct frequency and phase in order to counteract unwanted oscillations in combustion heat release and acoustic pressure.

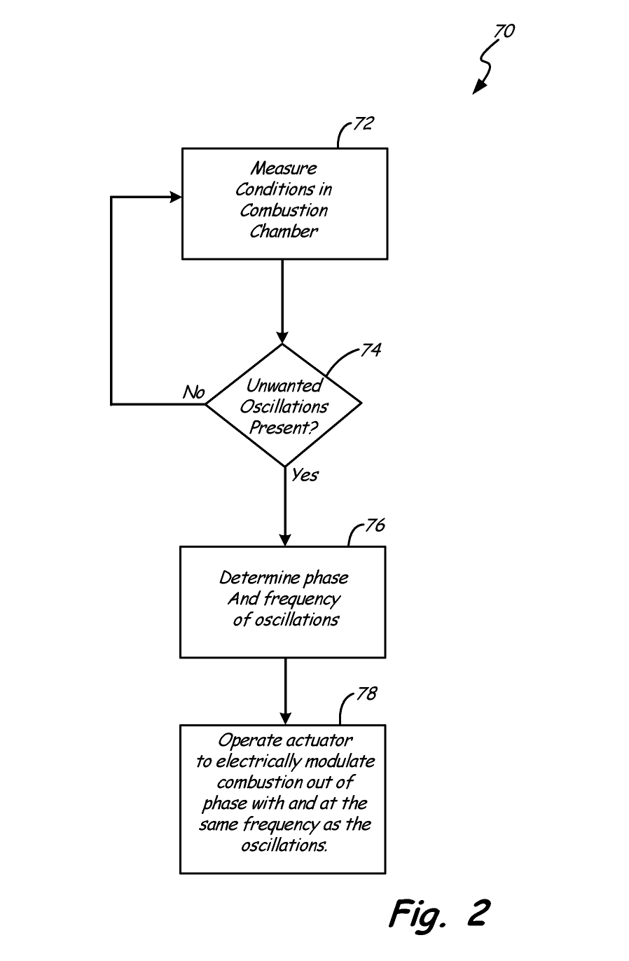

FIG. 2 is a flowchart illustrating a method 70 of electrically controlling combustion according to an embodiment of the present invention. At step 72, sensors 14 measure conditions within combustion chamber 12. At step 74, it is determined by controller 18 if any unwanted acoustic or combustion oscillations are present based upon input from sensors 14. If no unwanted oscillations are present, method 70 returns to step 72. If oscillations are present, method 70 proceeds to step 76. At step 76, controller 18 measures the phase and frequency of the unwanted oscillations. At step 78, in order to counteract the unwanted oscillations, controller 18 provides output to operate an actuator such that the combustion is electrically modulated out of phase with, and at the same frequency as the unwanted oscillations.

In this way, the present invention describes a system and method for electrically controlling combustion in order to counteract dynamic instabilities. Although the present invention has been described with reference to preferred embodiments, workers skilled in the art will recognize that changes may be made in form and detail without departing from the spirit and scope of the invention.

1. A system for electrically controlling combustion, the system comprising:
one or more sensors coupled to a combustion chamber for measuring conditions within the combustion chamber;
an actuator for electrically modulating combustion; and
a controller for detecting dynamic instabilities in the combustion chamber based upon input from the one or more sensors, and for operating the actuator to counteract the dynamic instabilities.

2. The system of claim 1, wherein the controller further detects a phase and frequency of the dynamic instabilities based upon input from the one or more sensors.

3. The system of claim 2, wherein the actuator is operated to counteract the dynamic instabilities by modulating heat release from a flame out of phase with, and at the same frequency as the detected dynamic instabilities.

4. The system of claim 3, wherein the actuator is a microwave source used to locally heat the flame.

5. The system of claim 3, wherein the actuator is a radio-frequency transmitter coupled with a coil, wherein the coil surrounds at least a portion of the flame and wherein the coil is used to induce a magnetic field that locally heats the flame.

6. The system of claim 3, wherein the actuator is a voltage source used to charge a fuel spray, wherein modulating the charge of the fuel spray modulates the heat release of the flame by modulating a fuel-to-air ratio at the flame.

7. The system of claim 1, wherein at least one of the one or more sensors is a microphone for measuring pressure within the combustion chamber.

8. The system of claim 1, wherein at least one of the one or more sensors is a light detector for sensing a chemiluminesence of the flame.

9. A method of electrically controlling combustion, the method comprising:
detecting dynamic instabilities in a combustion chamber using a controller, wherein the controller receives input regarding conditions within the combustion chamber from one or more sensors; and
electrically modulating combustion in the combustion chamber based upon the detected dynamic instabilities, wherein the controller operates an actuator to counteract the detected dynamic instabilities.

10. The method of claim 9, wherein detecting dynamic instabilities comprises:
the controller detecting oscillations in the combustion chamber based upon input from the one or more sensors; and
the controller detecting dynamic instabilities based upon an amplitude of the oscillations.

11. The method of claim 10, wherein detecting dynamic instabilities further comprises the controller detecting a phase and a frequency of the detected oscillations.

12. The method of claim 11, wherein counteracting the detected dynamic instabilities comprises oscillating heat release of a flame out of phase with, and at the same frequency as the detected dynamic instabilities.

13. The method of claim 9, wherein at least one of the one or more sensors is a pair of electrodes using an electromagnetic field to measure a flame in the combustion chamber based upon ions within the flame.

14. The method of claim 9, wherein the actuator is a microwave source that electrically modulates combustion by locally heating a flame.

15. The method of claim 9, wherein the actuator is a radio-frequency transmitter coupled with a coil, wherein the coil surrounds at least a portion of a flame and wherein the coil is used to induce a magnetic field that locally heats the flame.

16. The method of claim 9, wherein the actuator is a voltage source used to electrically modulate a fuel spray such that combustion is electrically modulated due to a fuel-to-air ratio being oscillated at a flame.
